(19) United States
(12) Patent Application Publication
(10) Pub. No.: US 2015/0146776 A1
(43) Pub. Date: May 28, 2015

(54) VIDEO IMAGE ENCODING DEVICE, VIDEO IMAGE ENCODING METHOD

(71) Applicant: FUJITSU LIMITED, Kawasaki-shi (JP)

(72) Inventors: Junpei KOYAMA, Shibuya (JP); Kimihiko Kazui, Kawasaki (JP)

(73) Assignee: FUJITSU LIMITED, Kawasaki-shi (JP)

(21) Appl. No.: 14/518,034

(22) Filed: Oct. 20, 2014

(30) Foreign Application Priority Data
Nov. 25, 2013 (JP) 2013-243206

(51) Int. Cl. H04N 19/593; H04N 19/124

(52) U.S. Cl. CPC H04N 19/593; H04N 19/124
USPC 375/240.03

(57) ABSTRACT

A video image encoding device includes a processor configured to execute a procedure. The procedure includes: computing a pixel average value and a pixel variation level for each of an encoding target block and an adjacent block; determining whether or not a false contour generation condition has been satisfied based on the pixel average values and pixel variation levels computed for the encoding target block and the adjacent block; and if the determination result is that the false contour generation condition has been satisfied, quantizing a prediction error image, representing a difference between an image of the encoding target block and a predicted image of the encoding target block encoded by the intra-frame prediction encoding, with a smaller quantization parameter than a set quantization parameter.

### CROSS-REFERENCE TO RELATED APPLICATION

This application is based upon and claims the benefit of priority of the prior Japanese Patent Application No. 2013-243206, filed on Nov. 25, 2013 the entire contents of which are incorporated herein by reference.

### FIELD

The embodiments discussed herein are related to a video image encoding device, a video image encoding method, and a video image capture device.

### BACKGROUND

Video images generally have an extremely large volume of data. Devices that handle video images accordingly compression-encode video images when transmitting video images to another device, or when storing video images in a storage device.

A typical standard protocol for a video image compression encoding method is Moving Picture Experts Group phase 2 (MPEG-2) drawn up by ISO/IEC (International Standardization Organization/International Electrotechnical Commission). Others include MPEG-4, and Advanced Video Coding (AVC, MPEG-4 AVC/H.264). There is also a new standard of High Efficiency Video Coding (HEVC, MPEG-H/H.265).

These standard protocols employ inter-frame encoding methods that encode a frame image (picture) subject to encoding using previous and following frame images in the display sequence, and intra-frame encoding methods that encode a frame image by employing only the frame image subject to encoding itself.

According to the standard protocols mentioned above, when encoding, for example, a video image containing pixel values that are substantially the same as each other, but with a gradation region where there is only a slight change in the pixel values according to position at a low bit rate, sometimes a false contour is detected in a video image that was not detected in the video image of the gradation region before encoding. Such a gradation region is, for example, a blue sky background. In such cases, generation of a false contour can be suppressed by quantization of the gradation region using a small quantization value, and increasing the volume of data of the gradation region.

### RELATED PATENT DOCUMENTS

Japanese Laid-Open Publication No. 2008-46346

Japanese Laid-Open Publication No. 2003-158741

Japanese Laid-Open Publication No. 2011-234070

Japanese Laid-Open Publication No. 2007-67469

### RELATED NON-PATENT DOCUMENTS

ITU-T H.265, “High efficiency video coding”.

### SUMMARY

According to an aspect of the embodiments, a video image encoding device including: a processor configured to execute a procedure, the procedure including: computing a pixel average value and a pixel variation level for each of an encoding target block, selected in a predetermined encoding sequence from plural blocks divided from a frame image to be encoded by intra-frame prediction encoding out of frame images contained in a video image, and at least one adjacent block out of plural adjacent blocks that are adjacent to the encoding target block; determining whether or not a false contour generation condition has been satisfied by the pixel variation levels computed for the encoding target block and the at least one adjacent block being less than a predetermined first threshold value, and an absolute difference value between the pixel average values computed for the encoding target block and the at least one adjacent block being greater than 0, but less than a predetermined second threshold value; and if the determination result is that the false contour generation condition has been satisfied, quantizing a prediction error image, representing a difference between an image of the encoding target block and a predicted image of the encoding target block encoded by the intra-frame prediction encoding, with a smaller quantization parameter than a set quantization parameter set according to a target bit rate.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of a video image capture device according to a first exemplary embodiment.

FIG. 2 is a block diagram of a computer that functions as a video image encoding device.

FIG. 3 is a flow chart illustrating a flow of video image processing.

FIG. 4 is an explanatory diagram regarding pixel average values of an encoding target block and of adjacent blocks.

FIG. 5 is an explanatory diagram regarding a boundary that generates a false contour.

FIG. 6 is a configuration diagram of a video image capture device according to a second exemplary embodiment.

FIG. 7 is an explanatory diagram regarding a prediction mode in inter-frame predicted image encoding.

FIG. 8 is a diagram illustrating an example of an image in which false contours are generated.

FIG. 9 is a diagram illustrating an example of pixel values of a gradation region.

FIG. 10 is an explanatory diagram regarding a case in which a false contour is generated in an image encoded at low bit rate.

FIG. 11 is an explanatory diagram regarding a manner in which a false contour is generated.

### DESCRIPTION OF EMBODIMENTS

Detailed explanation follows regarding exemplary embodiments of technology disclosed herein, with reference to the drawings.

First Exemplary Embodiment

Explanation follows regarding a cause of false contour generation. In AVC standard and HEVC standard image encoding methods a predicted image of an encoding target block is generated using encoded images of already encoded blocks adjacent at the top side and left side of the encoding target block, and the difference between the input image and the predicted image is encoded.

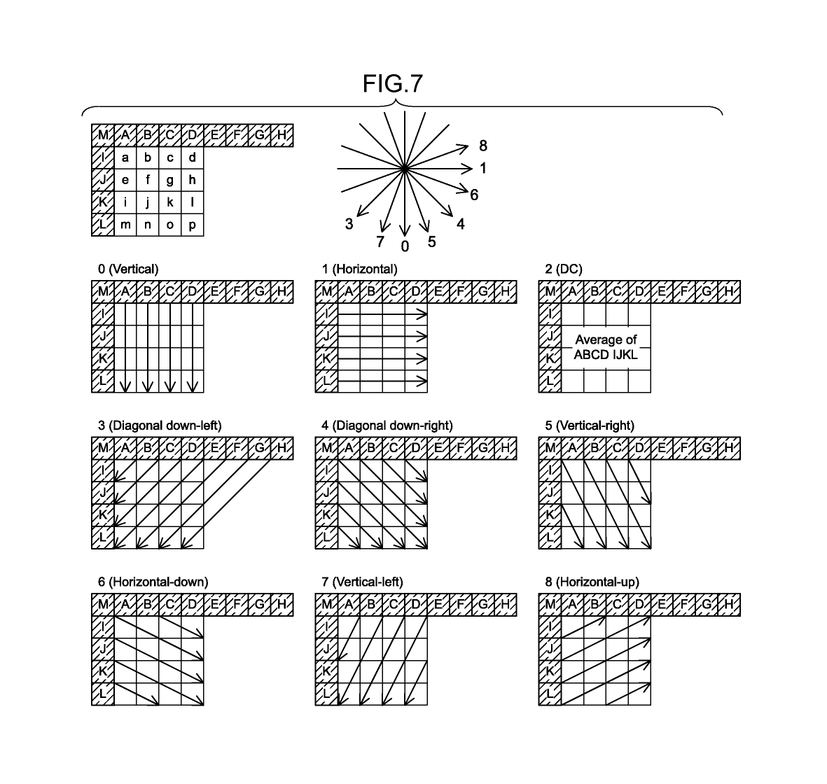

Explanation follows regarding a predicted image generation method for an encoding target block using an intra-frame encoding method in the AVC standard, with reference to FIG. 7. FIG. 7 displays 9 types of prediction mode defined in the AVC standard, and the generation method for predicted values of each of the pixels within a block for each of the prediction modes.

For example, in prediction mode 2 (DC), predicted values of pixels a to p within a 4×4 pixel encoding target block are set as the average value of all pixel values of the 8 pixels, pixels A to D and I to L, adjacent to the encoding target block.

In the prediction mode 0 (vertical), the predicted values of the pixels a, e, i, m are all set as the pixel value of the pixel A. Similarly, the predicted values of the pixels b, f, j, n are all set as the pixel value of the pixel B, the predicted values of the pixels c, g, k, o are all set as the pixel value of the pixel C, and the predicted values of the pixels d, h, l, p are all set as the pixel value of the pixel D.

For example, in cases in which the pixel values are all substantially the same as each other, and a video image, containing a gradation region (for example a blue sky background) with pixel values that change slightly according to position, is encoded at a lower bit rate, sometimes a false contour is detected that was not visible in the video image prior to encoding the gradation region.

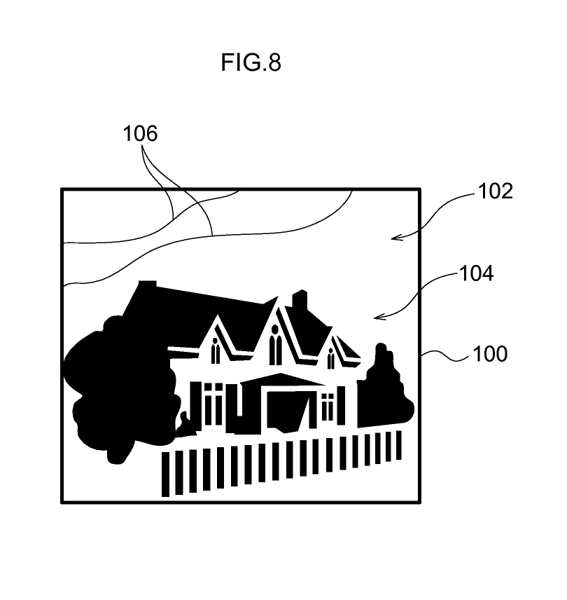

FIG. 8 illustrates an example of a false contour. The frame image 100 included in the video image illustrated in FIG. 8 is an example of a frame image including a background of blue sky 102, and a foreground of a house 104, and two false contours 106 are generated in the background of blue sky 102. The false contours 106 are visible as contour lines. Although there is a slight change in pixel values in the periphery of the false contours 106, since the background pixel values are substantially the same, the portion where the pixel values change slightly is readily visible to the human eye.

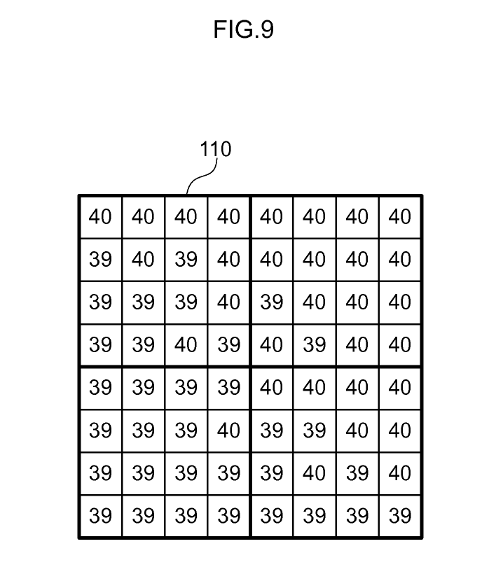

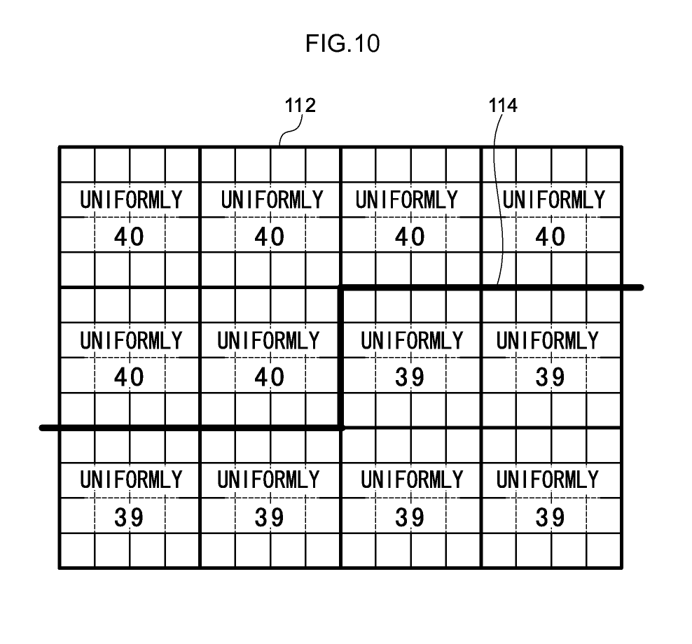

Explanation follows next regarding changes in pixel values before and after coding the region where the false contours are generated, with reference to FIG. 9 and FIG. 10.

FIG. 9 illustrates an example of pixel values of a block 110, a portion of a frame image in a video image prior to encoding, that has been divided into plural blocks. Each block is, for example, 4×4 pixels. The numerical values of each of the pixels are illustrated. In the example illustrated in FIG. 9, due to the pixel values of each of the pixels only having a slight difference, a false contour is not visible to the human eye due to the principle of error diffusion.

FIG. 10 illustrates an example of pixel values of a block 112 that is a portion of an encoded image after encoding. As illustrated in FIG. 10, pixel values within the block 112 are made uniform by encoding, and a false contour 114 is visible at boundaries between blocks with different pixel values. Making the pixel values within a block uniform by encoding in this manner causes the false contour.

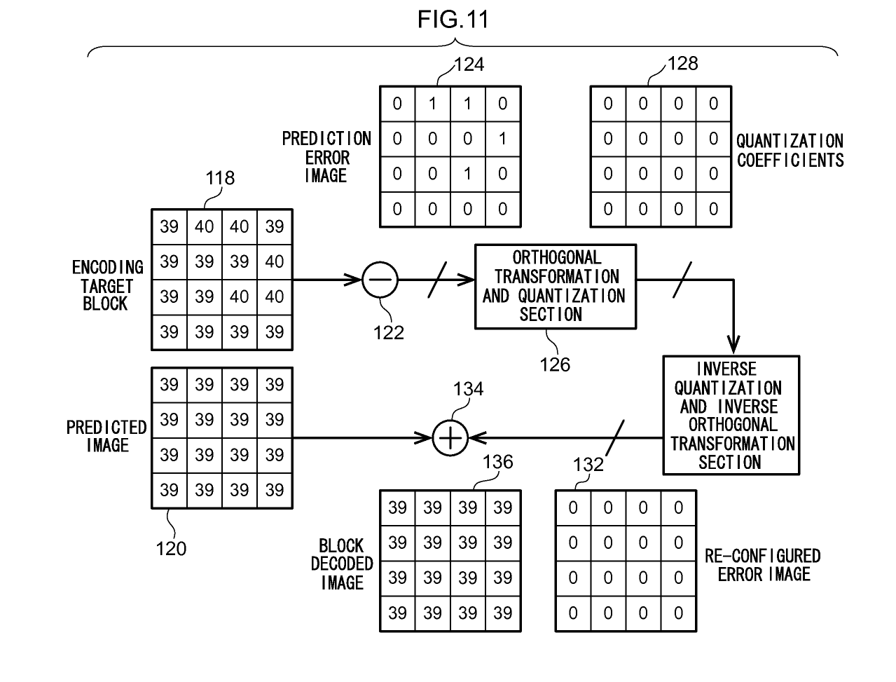

Explanation next follows regarding a manner in which uniformity of pixel values is generated within a block by intra-frame prediction encoding, with reference to FIG. 11.

As illustrated in FIG. 11, the average value of each of the pixels of block image 118 (an image prior to encoding), as an example of a 4×4 pixel encoding target block, is 39, and the maximum fluctuation in pixel values is “1”. Normally prediction mode 2 (DC) illustrated in FIG. 7 is selected as the prediction mode when intra-frame prediction encoding such an encoding target block. A predicted image 120 of the encoding target block is generated from pixel values of adjacent blocks that have already been encoded, and FIG. 11 illustrates an example in which the pixel values of each of the pixels of the predicted image 120 have become 39.

A prediction error image generation section 122 generates a prediction error image 124 by computing a difference between the pixel values of each of the pixels of the block image 118 of the encoding target block and the pixel values of each of the pixels of the predicted image 120, for each of the corresponding pixels. In the example of FIG. 11 the maximum difference for each of the corresponding pixels is “1”.

An orthogonal transformation and quantization section 126 computes quantization coefficients 128 for each of the pixels by subjecting the prediction error image 124 to orthogonal transformation processing and quantization processing. When encoding at a low bit rate, a quantization value (quantization parameter: Qp) is generally larger than a prediction error. The quantization coefficients are accordingly all 0.

An inverse quantization and inverse orthogonal transformation section 130 computes a re-configured error image 132 by subjecting the quantization coefficients 128 to inverse quantization processing and inverse orthogonal transformation processing. The pixel values of each of the pixels of the re-configured error image 132, similarly to the quantization coefficients 128, all become “0”.

A decoded image generation section 134 generates a block decoded image 136 by, for each corresponding pixel, adding together the pixel value of each of the pixels of the re-configured error image 132 and the pixel value of each of the pixels of the predicted image 120. Due to the pixel value of each of the pixels of the predicted image from intra-frame prediction encoding being uniform and the pixel value of each of the pixels of the re-configured error image 132 being “0”, as a result the pixel values of each of the pixels of the block decoded image 136 are uniform.

In order for the pixel values of each of the pixels of the block decoded image 136 not to be uniform, the quantization parameters, such as the quantization value, need to be sufficiently small, such that the pixel values of each of the pixels of the re-configured error image 132 are not all “0”.

In the first exemplary embodiment, explanation follows regarding a case in which generation of false contours is suppressed while suppressing an increase in the volume of data of encoded images, by quantization of blocks where there is a possibility of a false contour being generated using a small quantization parameter.

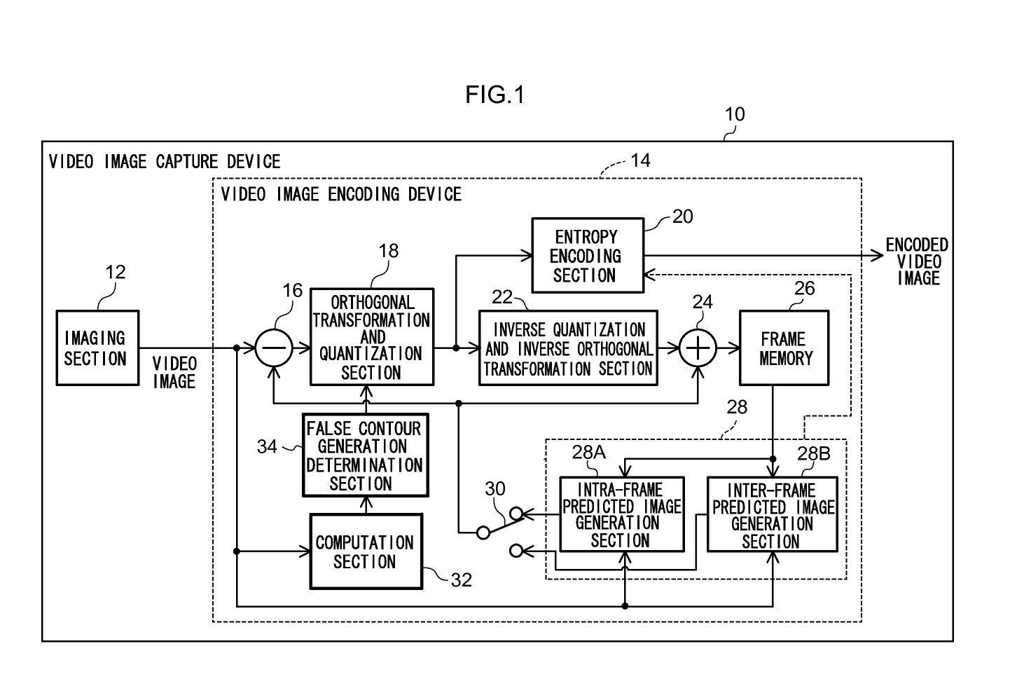

A video image capture device 10 according to a first exemplary embodiment is illustrated in FIG. 1. The video image capture device 10 includes an imaging section 12 and a video image encoding device 14.

The imaging section 12 includes an image pickup device, such as for example a Charge Coupled Device (CCD) or a Complementary Metal Oxide Semiconductor (CMOS), and lenses. During capture of a video image the imaging section 12 outputs captured video image data of the video to the video image encoding device 14. Namely, the imaging section 12 outputs image data of a frame image at each predetermined time to the video image encoding device 14.

The video image encoding device 14 includes a prediction error image generation section 16, an orthogonal transformation and quantization section 18, an entropy encoding section 20, an inverse quantization and inverse orthogonal transformation section 22, a decoded image generation section 24, and a frame memory 26. The video image encoding device 14 includes a predicted image generation section 28, a switching section 30, a computation section 32, and a false contour generation determination section 34. The predicted image generation section 28 includes an intra-frame predicted image generation section 28A and an inter-frame predicted image generation section 28B.

Encoding processing of a video image is performed by dividing a single frame image (also referred to as a single screen) into plural blocks sized according to a block size, and operating on each of the blocks. Each section of the video image encoding device 14 accordingly executes each processing by block unit. The encoding within a single frame image is performed in a predetermined encoding sequence, for example normally in the sequence from left to right, and from top to bottom, in the frame image. Thus explanation follows regarding the first exemplary embodiment of a case in which the encoding target blocks are selected and sequentially encoded in turn from the plural blocks according to the encoding sequence. For encoding, the optimum block size is selected from plural block sizes.

A frame image included in a video image output from the imaging section 12 is input to the prediction error image generation section 16. The prediction error image generation section 16 generates a prediction error image based on the image of the encoding target block from the input frame image, selected according to the encoding sequence, and the predicted image output by the predicted image generation section 28.

The prediction error image generation section 16 is supplied with the predicted image from the predicted image generation section 28 by block units. The predicted image is described later. The prediction error image generation section 16 generates a prediction error image by computing for each of the corresponding pixels the difference between pixel values of each of the pixels of the image of the encoding target block and pixel values of each of the pixels of the predicted image. The prediction error image generation section 16 outputs the prediction error image to the orthogonal transformation and quantization section 18. A prediction error image is accordingly generated in the prediction error image generation section 16.

The orthogonal transformation and quantization section 18 separates the prediction error image into frequency components in the horizontal and vertical directions by subjecting the prediction error image output from the prediction error image generation section 16 to orthogonal transformation processing. The orthogonal transformation and quantization section 18 generates quantization coefficients by quantizing data for each of the frequency components obtained by the orthogonal transformation processing, such as for example a discrete cosign transform (DCT) transformation using quantization parameters set according to a target bit rate. The target bit rate is, for example, set according to imaging mode of the video image set by a user (such as high image quality mode, standard image quality mode, low image quality mode).

A quantization value (Qp) and a quantization step size (Qstep) are included in the quantization parameter. In the first exemplary embodiment, for example, the quantization step size is fixed, and quantization coefficients are generated by dividing the quantization step size by data of each of the frequency components, obtained by orthogonal transformation processing using a quantization value set by multiplying the quantization step size by the quantization value corresponding to the target bit rate. The encoding volume of the prediction error image is reduced by such quantization. Note that if instruction is given by the false contour generation determination section 34, described below, to make the quantization value of the encoding target blocks smaller, then quantization is performed with a quantization value that is smaller than the set quantization value. Note that configuration may be made such that instead of making the quantization value smaller, a set quantization step size is set as a quantization step size corresponding to the set quantization value, and quantization is performed with a smaller quantization step size than the set quantization step size.

The orthogonal transformation and quantization section 18 outputs the quantization coefficients to the entropy encoding section 20 and the inverse quantization and inverse orthogonal transformation section 22. The orthogonal transformation and quantization section 18 is an example of a quantization section of technology disclosed herein.

The entropy encoding section 20 entropy encodes the quantization coefficients and the encoding parameter output by the orthogonal transformation and quantization section 18. The encoding parameter includes, for example, data for a movable vector detected by the inter-frame predicted image generation section 28B, described below, the prediction mode for generating the prediction image with the intra-frame prediction image generation section 28A, and the quantization value etc. for quantizing with the orthogonal transformation and quantization section 18. Entropy encoding is processing to allocate and encode codes of variable length according to the frequency of appearance of symbols. The encoded video images (bit streams) generated by entropy encoding are output to a predetermined output destination, such as for example a memory card.

The inverse quantization and inverse orthogonal transformation section 22 inverse quantizes the quantization coefficients output from the orthogonal transformation and quantization section 18 and generates inverse quantization coefficients. The inverse quantization and inverse orthogonal transformation section 22 performs inverse orthogonal transformation processing on the inverse quantized coefficients that have been inverse quantized. The inverse orthogonal transformation processing is processing to transform in the opposite direction to the transformation processing performed by the orthogonal transformation and quantization section 18. In cases in which quantization was performed by the orthogonal transformation and quantization section 18 with smaller quantization parameters than the set quantization parameters, inverse quantization is performed in the inverse quantization and inverse orthogonal transformation section 22 with smaller quantization parameters than the smaller quantization parameters.

A re-configured error image is obtained of an image of the same level as the prediction error image prior to encoding by performing the decoding processing using the inverse quantization and inverse orthogonal transformation section 22. However, as stated above, sometimes data of the prediction error image is lost when a gradation region is included in the frame image (see FIG. 11). The inverse quantization and inverse orthogonal transformation section 22 outputs the re-configured error image to the decoded image generation section 24.

The predicted image generated by the predicted image generation section 28 is supplied to the decoded image generation section 24 in block units.

The decoded image generation section 24 adds the pixel values of each of the pixels of the re-configured error image output by the inverse quantization and inverse orthogonal transformation section 22 to the pixel values of each of the pixels of the predicted images output by the predicted image generation section 28 for each corresponding pixel, generating a block decoded image of a decoded image of a decoding target block. The decoded image generation section 24 outputs the generated block decoded image to the frame memory 26.

Note that by performing processing with each of the above functional sections for each of the blocks contained in the encoding target frame image, the block decoded images are generated for each of the decoded blocks, and a decoded image of the entire frame image is generated. The decoded image of the entire frame image is referred to below simply as the decoded image.

The frame memory 26 stores in sequence each of the block decoded images output by the decoded image generation section 24. The decoded image of the entire decoded frame image is thereby stored. The stored decoded image is read by the inter-frame predicted image generation section 28B, described below, and employed for reference in movement vector detection processing, movement compensation processing, and the like when encoding another frame. Out of the stored decoded images, a decoded image employed for reference when generating a predicted image in the inter-frame predicted image generation section 28B is called a “reference image”.

The predicted image generation section 28 includes the intra-frame predicted image generation section 28A and the inter-frame predicted image generation section 28B. The predicted image generation section 28 generates the predicted image in block units, and outputs the prediction image block units to the prediction error image generation section 16 and the decoded image generation section 24, and also outputs to the entropy encoding section 20 the encoding parameter employed when generating the predicted image. The encoding parameter includes, for example, movement vector data detected during inter-frame prediction encoding, prediction mode when intra-frame prediction encoding is performed, and the like.

The intra-frame predicted image generation section 28A generates the predicted image in block units when encoding with an intra-frame prediction encoding method. Intra-frame prediction encoding methods do not employ other frame images, are methods that encode and decode an image using only the frame image subject to encoding, and are also referred to as in-screen prediction encoding methods or in-frame prediction encoding methods. A frame image encoded only by an intra-frame prediction encoding method is called an I picture. More specifically, within a single frame image, a predicted image is generate of the encoding target block according to the prediction mode, from the block decoded image of blocks that have already been encoded adjacent to the encoding target block. The method then encodes the difference between the generated predicted image and the image of the encoding target block.

The prediction mode is determined, for example, in the following manner. In order to select the most appropriated predicted image, for example, a predicted image is generated for all prediction modes, and encoding cost computed. All the encoding costs are then compared, and the prediction mode with the smallest encoding cost selected as the most appropriate prediction mode.

The inter-frame predicted image generation section 28B generates the predicted image in block units when encoding with an inter-frame prediction encoding method. In an inter-frame prediction encoding method, a block that is most alike an encoding target block is detected in a reference image with a different time stamp, and a movement vector is also detected. The method then encodes as a predicted image the difference between an image of a block compensated using the movement vector, and the image of the encoding target block. Inter-frame prediction encoding methods are also called between-screen prediction encoding methods or between-frame prediction encoding methods. Note that a frame image encoded with reference only to a past frame image using an inter-frame prediction encoding method is called a P picture, and a frame image encoded with reference to both a past frame image and a future frame image is called a B picture.

The switching section 30 selects either the predicted image generated by the intra-frame predicted image generation section 28A, or the predicted image generated by the inter-frame predicted image generation section 28B, and outputs the selected predicted image to the prediction error image generation section 16 and the decoded image generation section 24. More specifically, when the frame image input to the video image encoding device 14 is to be employed for I picture generation, the switching section 30 outputs the predicted image generated by the intra-frame predicted image generation section 28A to the prediction error image generation section 16 and the decoded image generation section 24. However, when the frame image input to the video image encoding device 14 is to be employed for P picture or B picture generation, the switching section 30 selects one or other of the predicted image generated by the intra-frame predicted image generation section 28A, or the predicted image generated by the inter-frame predicted image generation section 28B, and outputs the selected predicted image to the prediction error image generation section 16 and the decoded image generation section 24.

Although described in detail later, briefly the computation section 32 computes a pixel variation level and pixel average value based on the pixel values of each of the pixels of the encoding target block. The computation section 32 then computes the pixel variation level and pixel average value for each of adjacent blocks, based on the pixel values of each of the pixels of the adjacent blocks that are adjacent to the encoding target block. Note that the computation section 32 is an example of a computation section of technology disclosed herein.

Although described in detail later, briefly the false contour generation determination section 34 then determines whether or not a false contour will be generated at the boundary between the encoding target block and the adjacent blocks based on the pixel variation level and pixel average value for the encoding target block and for the adjacent blocks adjacent to the encoding target block. If determined that a false contour will be generated at the boundary between the encoding target block and the adjacent blocks, the false contour generation determination section 34 then instructs the orthogonal transformation and quantization section 18 to employ a smaller quantization value than the set quantization value during quantization of the encoding target block. The false contour generation determination section 34 is an example of a false contour generation determination section of technology disclosed herein.

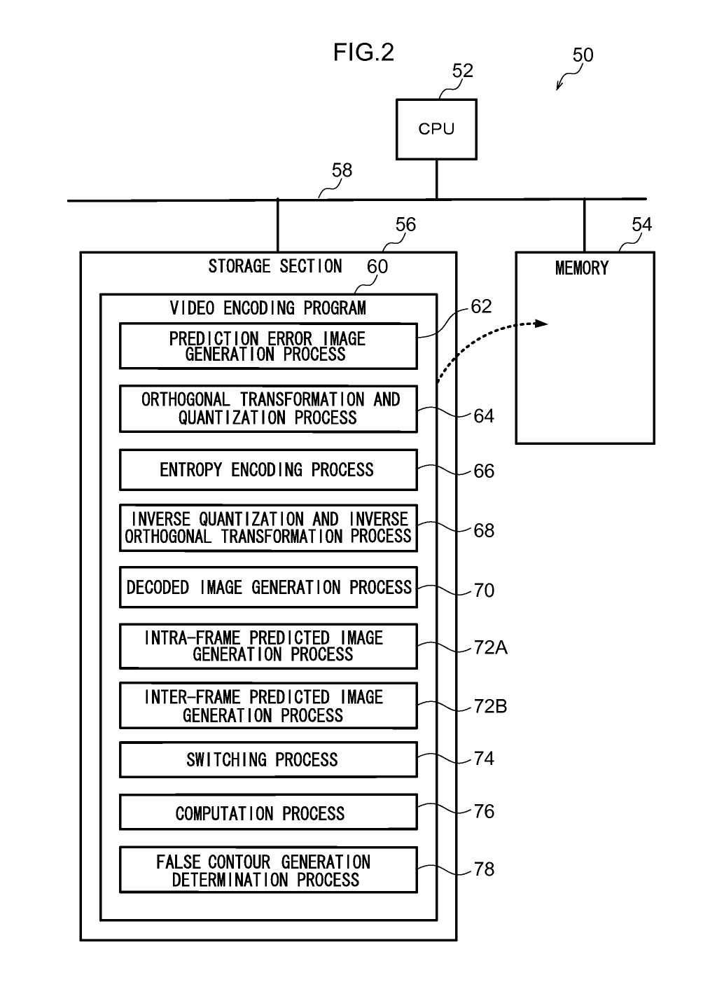

The video image encoding device 14 may, for example, be implemented by a computer 50 as illustrated in FIG. 2. The computer 50 includes a CPU 52, a memory 54, and a non-volatile storage section 56, with these connected together through a bus 58.

The storage section 56 may be implemented by a Hard Disk Drive (HDD), a flash memory, or the like. A video encoding program 60 is stored in the storage section 56, serving as a recording medium, for causing the computer 50 to function as the video image encoding device 14. The CPU 52 reads the video encoding program 60 from the storage section 56, expands the video encoding program 60 in the memory 54, and sequentially executes process of the video encoding program 60.

The video encoding program 60 includes a prediction error image generation process 62, an orthogonal transformation and quantization process 64, an entropy encoding process 66, an inverse quantization and inverse orthogonal transformation process 68, and a decoded image generation process 70. The video encoding program 60 also includes an intra-frame predicted image generation process 72A, an inter-frame predicted image generation process 72B, a switching process 74, a computation process 76, and a false contour generation determination process 78.

The CPU 52 operates as the prediction error image generation section 16 illustrated in FIG. 1 by executing the prediction error image generation process 62. The CPU 52 operates as the orthogonal transformation and quantization section 18 illustrated in FIG. 1 by executing the orthogonal transformation and quantization process 64. The CPU 52 operates as the entropy encoding section 20 illustrated in FIG. 1 by executing the entropy encoding process 66. The CPU 52 operates as the inverse quantization and inverse orthogonal transformation section 22 illustrated in FIG. 1 by executing the inverse quantization and inverse orthogonal transformation process 68. The CPU 52 operates as the decoded image generation section 24 illustrated in FIG. 1 by executing the decoded image generation process 70. The CPU 52 operates as the intra-frame predicted image generation section 28A illustrated in FIG. 1 by executing the intra-frame predicted image generation process 72A. The CPU 52 operates as the inter-frame predicted image generation section 28B illustrated in FIG. 1 by executing the inter-frame predicted image generation process 72B. The CPU 52 operates as the switching section 30 illustrated in FIG. 1 by executing the switching process 74. The CPU 52 operates as the computation section 32 illustrated in FIG. 1 by executing the computation process 76. The CPU 52 operates as the false contour generation determination section 34 illustrated in FIG. 1 by executing the false contour generation determination process 78.

The computer 50 implemented by the video encoding program 60 accordingly functions as the video image encoding device 14. The video encoding program 60 is an example of a video image encoding program of technology disclosed herein.

The video image encoding device 14 may be implemented with, for example, a semiconductor integrated circuit, and more specifically with an Application Specific Integrated Circuit (ASIC) or the like.

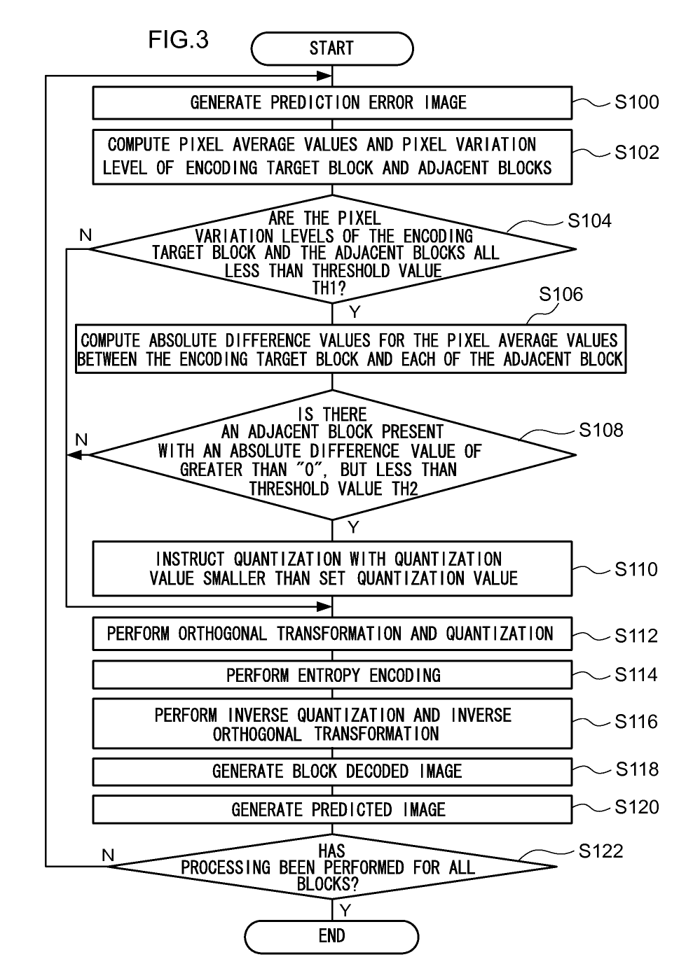

Explanation next follows regarding operation of the first exemplary embodiment. When a user instructs capture start of a video image, capture of a video image is started by the imaging section 12, and frame images included in the video image are output sequentially to the video image encoding device 14. The video image encoding device 14 executes the video image encoding processing illustrated in FIG. 3 at input from the imaging section 12 of each frame image contained in the video image. The video image encoding processing illustrated in FIG. 3 is for a case in which the frame image input to the video image encoding device 14 is to be employed for generation of an I picture, namely when inter-frame prediction encoding processing is to be performed, and explanation of inter-frame prediction encoding processing is omitted.

At step S100, the prediction error image generation section 16 generates a prediction error image based on the image of the encoding target block, selected from the input frame image according to a predetermined encoding sequence, and the predicted image. Namely, the prediction error image generation section 16 generates a prediction error image by computing the difference between the pixel values of each of the pixels of the image of the encoding target block, and the pixel values of each of the pixels of the predicted image, for each of the corresponding pixels. The prediction error image generation section 16 outputs the generated prediction error image to the orthogonal transformation and quantization section 18.

At step S102, the computation section 32 computes the pixel average value and the pixel variation level based on the pixel values of the encoding target block, and also computes the pixel average value and the pixel variation level based on the pixel values of the adjacent blocks adjacent to the encoding target block. In the first exemplary embodiment, the pixel values of the adjacent blocks of the frame image input from the imaging section 12 are employed when computing the pixel average value and the pixel variation level of the adjacent blocks. The adjacent blocks are blocks that have a boundary line to the encoding target block, and more specifically, refer to the 4 adjacent blocks that have 1 side that touches the encoding target block at the top and bottom, and the left and right of the encoding target block.

Pixel average values A are, for example, computed according to the following Equation (1).

$$A = \frac{1}{{N}^{2}} {\sum }_{i = 0}^{{N}^{2} - 1} p [ i ] \qquad Equation ( 1 )$$

Wherein, N is the number of pixels on one side of a square block, an p[i] is the i^{th} pixel value in a block (i=0, 1, 2, and so on to N²−1).

The pixel variation level is a distribution D of pixel values for all of the pixels in a block. Distribution D is computed according the following Equation (2) using the pixel average values A computed by Equation (1).

$$D = \frac{1}{{N}^{2}} {\sum }_{i = 0}^{{N}^{2} - 1} {( p [ i ] - A )}^{2} \qquad Equation ( 2 )$$

In the first exemplary embodiment, the flatness level of the block image can be detected by using the distribution of the pixel values of the pixels within a block as the pixel variation level. Namely, the smaller the pixel variation level, the smaller the variation in the pixel values of each of the pixels in a block, and so the image of the block is referred to as having a higher flatness level. The larger the pixel variation level, the larger the variation in the pixel values of each of the pixels in a block, and so the image of the block is referred to as having a lower flatness level.

The standard deviation of pixel values of each of the pixels in a block may be employed as the pixel variation level instead of employing the distribution D of the pixel values of each of the pixels in a block as the pixel variation level.

At step S104, the false contour generation determination section 34 determines whether or not the encoding processing target block and the adjacent blocks are all flat based on the pixel variation level of the encoding target block and the pixel variation level of the adjacent blocks adjacent to the encoding target block.

If the pixel variation level of the encoding target block computed according to Equation (2) is less than a predetermined first threshold value TH1 (referred to below simply as the threshold value TH1), the false contour generation determination section 34 determines the pixel values of the encoding target block to be uniform. Namely, the image of the encoding target block is determined to be flat. Similarly for the adjacent blocks, the false contour generation determination section 34 determines that the pixel values of the adjacent blocks are uniform if the pixel variation level computed according to Equation (2) for the adjacent blocks is less than the threshold value TH1. The false contour generation determination section 34 determines whether or not the pixel values of all the adjacent blocks are uniform. The threshold value TH1 is set at a value that enables an image of a block to be determined as flat if the pixel variation level in that block is less than threshold value TH1, and is, for example, set at a value of about from 1% to 2% of the number of gradation levels of the image. For example, if the pixel values of each of the pixels are expressed by 8 bits (256 gradation levels) then the threshold value TH1 may be set to a value of about “3” or “4”.

Processing proceeds to step S106 if the pixel variation level of the encoding target block and the pixel variation level of the adjacent blocks are all less than the threshold value TH1, namely if the encoding target block and the adjacent blocks are all flat. However, processing proceeds to step S112 if there is any one or more block in which the pixel variation level is the threshold value TH1 or greater, namely if there is any one or more non-flat block present.

At step S106, the false contour generation determination section 34 computes the absolute difference values between the pixel average values of the encoding target block and the pixel average values of the adjacent blocks for each of the adjacent blocks. The absolute difference value S is computed according to Equation (3), wherein Al is the pixel average values of the encoding target block, and A2 is the pixel average values of the adjacent block.

S=|A1−A2| Equation (3)

At step S108, the false contour generation determination section 34 determines whether or not there is one of the absolute difference values computed at step S106 that is greater than “0”, and less than a second threshold value TH2 (referred to below simply as threshold value TH2). Namely, the false contour generation determination section 34 determines whether or not there is an adjacent block present for which there is a possibility of a false contour being generated. The threshold value TH2 is set at a value enabling determination that a false contour might be generated if the absolute difference value is less than the threshold value TH2, and is, for example, set at a value of about 0.5% of the number of gradations of an image. For example, if the pixel values of each of the pixels are expressed by 8 bits (256 gradation levels) then the threshold value TH2 may be set to a value of about “1” or “2”.

Processing proceeds to step S110 if there is an absolute difference value present that is larger than “0” and less than the threshold value TH2, namely an adjacent block is present with a possibility of a false contour being generated. However, processing proceeds to step S112 if there is no absolute difference value present that is larger than “0” and less than the threshold value TH2, namely there is no adjacent block present with a possibility of a false contour being generated.

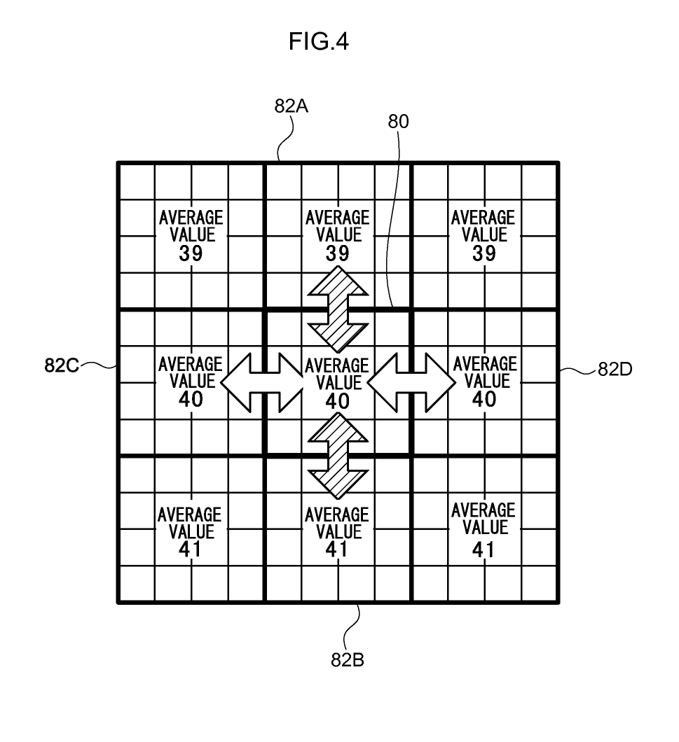

As illustrated in FIG. 4, for example, say the pixel variation level of an encoding target block 80 and adjacent blocks 82A to 82D are all determined to be less than the threshold value TH1, the pixel average value of the encoding target block 80 is “40”, and the pixel average value of the adjacent block 82A at the top side thereof is “39”. Say the pixel average value of the adjacent block 82B at the bottom side is “41”, the pixel average value of the adjacent block 82C at the left side is “40”, and the pixel average value of the adjacent block 82D at the right side is “40”.

In such a case, the absolute difference value between the pixel average value of the encoding target block 80 and the pixel average value of the top side adjacent block 82A, and the absolute difference value between the pixel average value of the encoding target block 80 and the pixel average value of the bottom side adjacent block 82B are “1”. Thus if, for example, “2” is set as the threshold value TH2, then determination is made that there is a possibility of a false contour being generated at the boundary between the encoding target block 80 and the top side adjacent block 82A, and at the boundary between the encoding target block 80 and the bottom side adjacent block 82B.

However, the absolute difference value between the pixel average value of the encoding target block 80 and the pixel average value of the left side adjacent block 82C, and the absolute difference value between the pixel average value of the encoding target block 80 and the pixel average value of the right side adjacent block 82D, are “0”. Determination is accordingly made that there is no possibility of a false contour being generated at the boundary between the encoding target block 80 and the left side adjacent block 82C, or at the boundary between the encoding target block 80 and the right side adjacent block 82D.

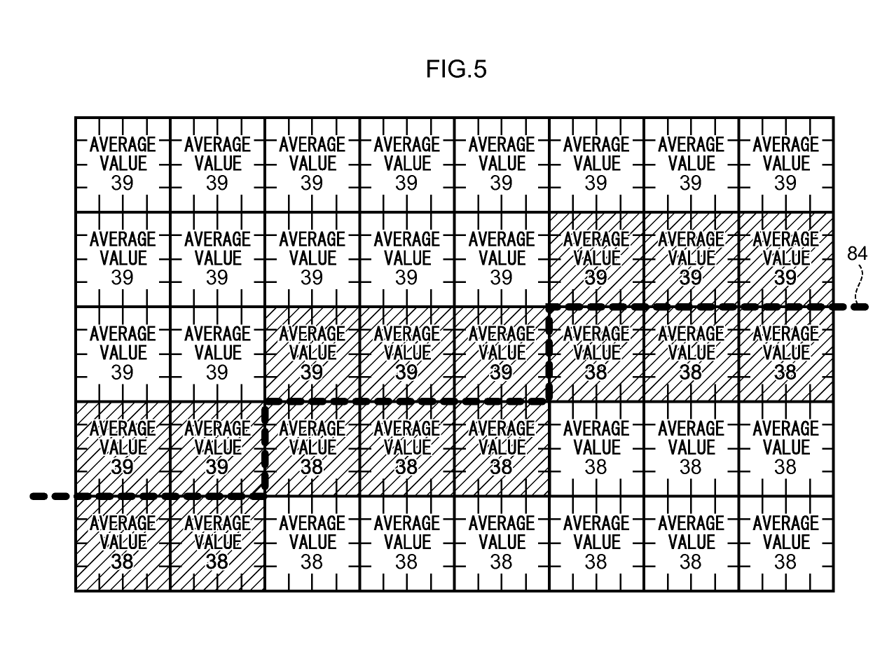

Thus the above determination enables, for example as illustrated in FIG. 5, a boundary 84 to be identified as having a possibility of a false contour being generated. In the example of FIG. 5, the diagonal hatching blocks are blocks determined to have a possibility of a false contour being generated at a boundary with an adjacent block due to there being an absolute difference value greater than “0” and less than threshold value TH2.

Configuration may be made such that determination is not made for all the absolute difference value as to whether or not they are greater than “0” and less than threshold value TH2. Namely, processing may proceed straight to step S110 as soon as the first case of the presence of an adjacent block with an absolute difference value greater than “0” and less than threshold value TH2 is detected, without the determination at step S108 being performed for the absolute difference values of the remaining adjacent blocks.

At step S110, the false contour generation determination section 34 instructs the orthogonal transformation and quantization section 18 to quantize using a smaller quantization value than the set quantization value. For example, instruction is made to the orthogonal transformation and quantization section 18 to quantize using a quantization value of the set quantization value from which a predetermined value has been subtracted. The reduced value is set as a value capable of determining so as to suppress generation of false contour if the predetermined value is subtracted from the set quantization value. For example, the orthogonal transformation and quantization section 18 is instructed to use as a new quantization value a value of the set quantization value from which “6” has been subtracted. For example, in the case of linear quantization in which the quantization step size is proportional to the quantization value, subtracting “6” from the set quantization value results in ½ the quantization step size. The data volume accordingly becomes twice that when quantization is performed with the set quantization value. The value subtracted is not limited to “6”.

At step S112, the orthogonal transformation and quantization section 18 performs orthogonal transformation processing on the data of the prediction error image output from the prediction error image generation section 16. In cases in which the orthogonal transformation and quantization section 18 has been instructed to quantize with a quantization value smaller than the set quantization value from the false contour generation determination section 34, the data after orthogonal transformation processing with the smaller quantization value than the set quantization value is quantized and a quantization coefficient is generated. In the absence of such an instruction, the data after orthogonal transformation processing with the set quantization value is quantized and a quantization coefficient is generated.

At step S114, the entropy encoding section 20 entropy encodes the quantization coefficient after quantization generated by the orthogonal transformation and quantization section 18, and the encoding parameter output by the predicted image generation section 28.

At step S116, the inverse quantization and inverse orthogonal transformation section 22 inverse quantizes the quantization coefficient output from the orthogonal transformation and quantization section 18. The inverse quantization and inverse orthogonal transformation section 22 subjects the inverse quantized inverse quantization coefficient to inverse orthogonal transformation processing, and generates the re-configured error image.

At step S118, the decoded image generation section 24 generates a block decoded image of the decoded image of the encoding target block by adding the pixel values of each of the pixels of the re-configured error image to the pixel values of each of the pixels of the predicted image, for each of the corresponding pixels, and outputs the generated block decoded image to the frame memory 26.

At step S120, the intra-frame predicted image generation section 28A generates a predicted image according to an intra-frame prediction encoding method. Namely, a predicted image of an encoding target block is generated according to the prediction mode from the block decoded image of the blocks that have completed encoding adjacent to the encoding target block. For example, in cases in which the prediction mode 2 (DC) illustrated in FIG. 7 is selected as the prediction mode, predicted values of the pixels a to p within the encoding target block are set with the average value of all the pixel values of the 8 pixels, the pixels A to D and pixels I to L, adjacent to the encoding target block. The intra-frame predicted image generation section 28A then outputs the generated predicted image to the prediction error image generation section 16 and the decoded image generation section 24.

At step S122, the prediction error image generation section 16 determines whether or not the encoding processing has been executed for all of the blocks of the frame image, namely whether or not the processing of steps S100 to S120 have been executed for all of the blocks. Processing proceeds to step S100 and processing similar to that described above is executed if there is still an unprocessed block present, and the present routine is ended if encoding processing has been completed for all of the blocks.

Thus in the first exemplary embodiment, determination is made that a false contour generation condition is satisfied if the pixel variation level of the encoding target block and adjacent blocks are less than the threshold value TH1, and the absolute difference value between the pixel average values of the encoding target block and the adjacent blocks is greater than 0, but less than the threshold value TH2. Quantization is then performed with a smaller quantization value if the false contour generation condition is satisfied.

For example, when a video image including a gradation region (such as blue sky background) as described above is being encoded, the quantization value is only made smaller for the blocks out of the gradation region where there is a possibility of false contour being generated, and the quantization value is not made smaller for all of the gradation region. This thereby enables the generation of false contours to be suppressed, while also suppressing an increase in the volume of data of the encoded image.

Second Exemplary Embodiment

Explanation follows regarding a second exemplary embodiment of technology disclosed herein. Portions similar to those of the first exemplary embodiment are allocated the same reference numerals and further explanation is omitted thereof, and explanation will focus on the portions that differ from the first exemplary embodiment.

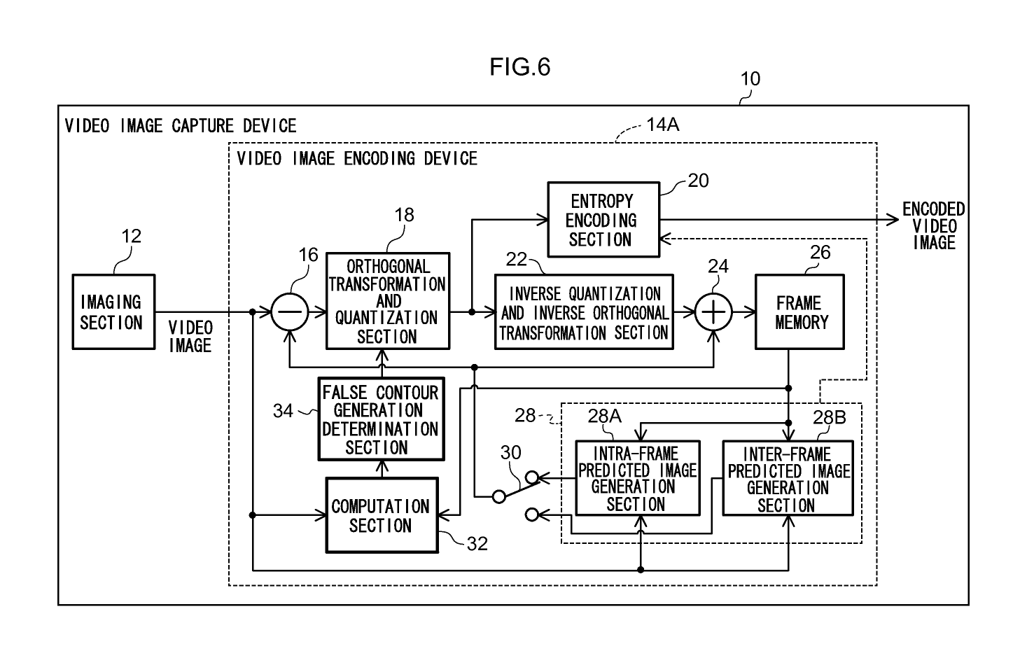

A video image encoding device 14A according to the second exemplary embodiment is illustrated in FIG. 6. A point in which the video image encoding device 14A differs from the video image encoding device 14 illustrated in FIG. 1 is that a computation section 32 is connected to a frame memory 26, with other configuration being similar thereto, and so explanation omitted thereof.

In the first exemplary embodiment, at step S102 of FIG. 3, the computation section 32 employs the pixel values of a frame image output from the imaging section 12, and computes the pixel variation level and the pixel average value using the pixel values for each of the pixels of adjacent blocks.

In contrast thereto, for any adjacent blocks that have already been encoded and have a block decoded image stored in the frame memory 26, the computation section 32 of the second exemplary embodiment employs the pixel values of the block decoded image as the pixel values of each of the pixels of the adjacent block, and computes the pixel variation level and the pixel average value using the pixel values of the block decoded image.

Namely, since the adjacent blocks at the top side and the left side of the encoding target block have already been encoded and have block decoded images stored in the frame memory 26, the pixel values of the block decoded images stored in the frame memory 26 are employed for these adjacent blocks.

There is no limitation to the already encoded blocks being the adjacent blocks at the top side and left side of the encoding target block in cases in which the encoding sequence in the frame image differs from the normal sequence of from left to right, and from top to bottom. In such cases the pixel values of block decoded images may be employed for the adjacent blocks that have already been encoded.

This thereby enables the precision of determination as to whether or not a false contour will be generated to be raised by computing the pixel variation level and pixel average value using the pixel values of the block decoded images as the pixel values of the adjacent blocks.

At step S102 of FIG. 3, the pixel average value is computed from the pixel values of all the pixels in the block when computing the pixel average values of the encoding target block and the adjacent blocks; however there is no limitation thereto. For example, a pixel average value may be computed after excluding a portion of the pixels in the block.

Processing proceeds to step S106 if, at step S104 of FIG. 3, the pixel variation level of all of the adjacent blocks are all less than the threshold value TH1, however processing may proceeds to step S106 even if the pixel variation level of a portion of the adjacent blocks is not less than the threshold value TH1.

The block size of each of the blocks is also usually fixed in a single frame image when encoding a video image, however sometimes a single block is divided into plural sub-blocks then encoded. In such cases the block size is sometimes different between the encoding target block and each of the adjacent blocks.

For example, in cases in which the block size of the encoding target block is larger than the block size of the adjacent block at the left side, there are plural adjacent blocks adjacent to the left side of the encoding target block. In such cases, all of the adjacent blocks adjacent at the left side of the encoding target block are preferably subjected to the processing of FIG. 3. However, if the block size of the encoding target block is smaller than the block size of the adjacent block at the left side of the encoding target block, then, instead of using the entire region of the adjacent block, a region in the adjacent block that is adjacent to the encoding target block and of the same size as the encoding target block may be treated as the adjacent block.

Explanation has been given above of a mode in which the video encoding program 60 serving as a video image encoding program according to technology disclosed herein is pre-stored (installed) on the storage section 56, however there is no limitation thereto. The video image encoding program according to technology disclosed herein may be provided in a format recorded on a recording medium, such as a CD-ROM or a DVD-ROM.

The video image encoding device 14 may, for example, also be installed in a video camera, a mobile phone, a smart phone, a moving picture transmitting device, a moving picture reception device, a video phone system, a personal computer, or the like.

An aspect of technology disclosed herein has the advantageous effect of enabling generation of false contours to be suppressed while suppressing an increase in the volume of data of an encoded image.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A video image encoding device comprising:
a processor configured to execute a procedure, the procedure comprising:
computing a pixel average value and a pixel variation level for each of an encoding target block, selected in a predetermined encoding sequence from a plurality of blocks divided from a frame image to be encoded by intra-frame prediction encoding out of frame images contained in a video image, and at least one adjacent block out of a plurality of adjacent blocks that are adjacent to the encoding target block;
determining whether or not a false contour generation condition has been satisfied by the pixel variation levels computed for the encoding target block and the at least one adjacent block being less than a predetermined first threshold value, and an absolute difference value between the pixel average values computed for the encoding target block and the at least one adjacent block being greater than 0, but less than a predetermined second threshold value; and
if the determination result is that the false contour generation condition has been satisfied, quantizing a prediction error image, representing a difference between an image of the encoding target block and a predicted image of the encoding target block encoded by the intra-frame prediction encoding, with a smaller quantization parameter than a set quantization parameter set according to a target bit rate.

2. The video image encoding device of claim 1, wherein
for any adjacent blocks that have completed encoding by the intra-frame prediction encoding out of the at least one adjacent block, pixel values of a block decoded image decoded from the encoding-complete adjacent block are employed to compute the pixel variation level and the pixel average value.

3. The video image encoding device of claim 1, wherein
the pixel variation level is computed for all of the plural adjacent blocks; and
determination is made as to whether or not a false contour generation condition is satisfied of the pixel variation levels computed for all of the encoding target block and the plurality of adjacent blocks being less than the predetermined first threshold value, and the absolute difference values between the pixel average values computed for the encoding target block and all the respective plurality of adjacent blocks being greater than 0, but less than the predetermined second threshold value.

4. The video image encoding device of claim 1, wherein
the pixel average value of the encoding target block is an average value of pixel values for all the pixels in the encoding target block, and the pixel average value of the adjacent block is the average value of pixel values for all the pixels of the adjacent block.

5. The video image encoding device of claim 1, wherein
the pixel variation level of the encoding target block is a distribution of pixel values for each of the pixels in the encoding target block, and the pixel variation level of the adjacent block is a distribution of pixel values of each of the pixels of the adjacent block.

6. A video image encoding method comprising:
by a processor, computing a pixel average value and a pixel variation level for each of an encoding target block, selected in a predetermined encoding sequence from a plurality of blocks divided from a frame image to be encoded by intra-frame prediction encoding out of frame images contained in a video image, and at least one adjacent block out of a plurality of adjacent blocks that are adjacent to the encoding target block;
by a processor, determining whether or not a false contour generation condition has been satisfied by the pixel variation levels computed for the encoding target block and the at least one adjacent block being less than a predetermined first threshold value, and an absolute difference value between the pixel average values computed for the encoding target block and the at least one adjacent block being greater than 0, but less than a predetermined second threshold value; and
by a processor, if the determination result is that the false contour generation condition has been satisfied, quantizing a prediction error image, representing a difference between an image of the encoding target block and a predicted image of the encoding target block encoded by the intra-frame prediction encoding, with a smaller quantization parameter than a set quantization parameter set according to a target bit rate.

7. The video image encoding method of claim 6, wherein
for any adjacent blocks that have completed encoding by the intra-frame prediction encoding out of the at least one adjacent block, pixel values of a block decoded image decoded from the encoding-complete adjacent block are employed to compute the pixel variation level and the pixel average value.

8. The video image encoding method of claim 6, wherein
by a processor, the pixel variation level is computed for all of the plural adjacent blocks; and
by a processor, determination is made as to whether or not a false contour generation condition is satisfied of the pixel variation levels for all of the encoding target block and the plurality of adjacent blocks being less than the first threshold value, and the absolute difference values between the pixel average values for the encoding target block and all the respective plurality of adjacent blocks being greater than 0, but less than the predetermined second threshold value.

9. The video image encoding method of claim 6, wherein
the pixel average value of the encoding target block is an average value of pixel values for all the pixels in the encoding target block, and the pixel average value of the adjacent block is the average value of pixel values for all the pixels of the adjacent block.

10. The video image encoding method of claim 6, wherein
the pixel variation level of the encoding target block is a distribution of pixel values for each of the pixels in the encoding target block, and the pixel variation level of the adjacent block is a distribution of pixel values of each of the pixels of the adjacent block.

11. A non-transitory recording medium storing a program that causes a computer to execute a video image encoding process, the process comprising:
computing a pixel average value and a pixel variation level for each of an encoding target block, selected in a predetermined encoding sequence from a plurality of blocks divided from a frame image to be encoded by intra-frame prediction encoding out of frame images contained in a video image, and at least one adjacent block out of a plurality of adjacent blocks that are adjacent to the encoding target block;
determining whether or not a false contour generation condition has been satisfied by the pixel variation levels computed for the encoding target block and the at least one adjacent block being less than a predetermined first threshold value, and an absolute difference value between the pixel average values computed for the encoding target block and the at least one adjacent block being greater than 0, but less than a predetermined second threshold value; and
if the determination result is that the false contour generation condition has been satisfied, quantizing a prediction error image, representing a difference between an image of the encoding target block and a predicted image of the encoding target block encoded by the intra-frame prediction encoding, with a smaller quantization parameter than a set quantization parameter set according to a target bit rate.

12. The non-transitory recording medium of claim 11, wherein the video image encoding process comprises:
for any adjacent blocks that have completed encoding by the intra-frame prediction encoding out of the at least one adjacent block, employing pixel values of a block decoded image decoded from the encoding-complete adjacent block to compute the pixel variation level and the pixel average value.

13. The non-transitory recording medium of claim 11, the video image encoding process comprising:
computing the pixel variation level for all of the plural adjacent blocks; and
determining whether or not a false contour generation condition is satisfied of the pixel variation levels computed for all of the encoding target block and the plurality of adjacent blocks being less than the predetermined first threshold value, and the absolute difference values between the pixel average values computed for the encoding target block and all the respective plurality of adjacent blocks being greater than 0, but less than the predetermined second threshold value.

14. The non-transitory recording medium of claim 11, wherein
the pixel average value of the encoding target block is an average value of pixel values for all the pixels in the encoding target block, and the pixel average value of the adjacent block is the average value of pixel values for all the pixels of the adjacent block.

15. The non-transitory recording medium of claim 11, wherein
the pixel variation level of the encoding target block is a distribution of pixel values for each of the pixels in the encoding target block, and the pixel variation level of the adjacent block is a distribution of pixel values of each of the pixels of the adjacent block.
